(19) United States
(12) Patent Application Publication
(10) Pub. No.: US 2019/0354978 A1
(43) Pub. Date: Nov. 21, 2019

(54) SERVER AND METHOD FOR MANAGING AN AUTHORIZATION AMOUNT OVER A PLURALITY OF PAYMENTS

(71) Applicant: MASTERCARD INTERNATIONAL INCORPORATED, Purchase, NY (US)

(72) Inventors: Abhishek CHATURVEDI, Lucknow (IN); Parameswaran VENKATASUBRAMANIAN, Chennai (IN); Lakshmi Narasimhan RAMANUJAM, Chennai (IN)

(21) Appl. No.: 16/407,399

(22) Filed: May 9, 2019

(30) Foreign Application Priority Data
May 17, 2018 (SG) 10201804194V

(51) Int. Cl. G06Q 20/40; G06Q 20/22

(52) U.S. Cl. CPC G06Q 20/403; G06Q 20/29

(57) ABSTRACT

A server for an authorization amount shown in a transaction request over a plurality of payments using an account, where the authorization amount exceeds a limit determined for the account, is configured to receive a request to update the authorization amount with a transaction amount, the request indicating account details corresponding to the account, the authorization amount and the transaction amount to be paid in one of the plurality of payments; retrieve, from a predetermined database, a score representing a credibility of a user using the account in response to receiving the request; compare the retrieved score with a threshold to determine whether or not the retrieved score is equal to or higher than the threshold; and approve the request to update the authorization amount in the transaction request if it is determined that the retrieved score is equal to or higher than the threshold.

### TECHNICAL FIELD

The present invention relates broadly, but not exclusively, to servers and methods for managing an authorization amount over a plurality of payments using a user account.

### BACKGROUND

Recently, several types of payment for purchasing products or services are available. For example, an authorization amount for purchasing a good and/or service (or product) can be paid over a plurality of payments (or installments) instead of a one-time payment. In the event that a transaction relates to a plurality of products, the authorization amount of the transaction is a total sum of the plurality of products.

Payment over a plurality of payments is beneficial for consumers who cannot afford to purchase expensive goods and/or services (or products) at one time. This is especially important to consumers who have a credit limit that is higher than an authorization amount representing one or more products that they wish to purchase. The authorization amount represents an amount that needs to be approved by facilitating entity before a transaction may proceed. The credit limit (or limit) represents the maximum amount that an owner of the account may spend in a specific time period, (typically, a month). Conventionally, when the owner of the account would want to buy a product, an authorization amount is compared with the credit limit of the account to determine whether or not to approve a transaction. In this conventional example, since the authorization amount is one that is to be settled in a single transaction, it is also the transaction amount. That is, if the authorization amount exceeds the credit limit, the transaction will not be approved and the owner will not be able to buy the product.

In recent times, there are other types of payment options available. For example, it is possible for an owner to pay the authorization amount over a payment schedule (or over a plurality of payments) but there are very strict and inflexible terms, fees, and payment schedules. For example, the authorization amount is still compared with the credit limit of the account to determine whether or not to approve a transaction. It is important to provide an opportunity to purchase the one or more products represented by the authorization amount. It is also important to include other parameters to allow an entity (e.g., a financial institute) which is facilitating the plurality of payments prior to it determine whether or not to approve the transaction.

A need therefore exists to provide servers and methods for managing a request to settle an authorization amount over a plurality of payments using a user account that address one or more of the above-mentioned problems.

### BRIEF SUMMARY

In a first aspect, there is a server for managing an authorization amount shown in a transaction request over a plurality of payments using an account, the authorization amount exceeding a limit determined for the account, the server comprising:

at least one processor; and

at least one memory including computer program code, the at least one memory and the computer program code configured to, with the at least one processor, cause the server at least to:

receive a request to update the authorization amount with a transaction amount, the request indicating account details corresponding to the account, the authorization amount and the transaction amount to be paid in one of the plurality of payments;

retrieve, from a predetermined database, a score representing a credibility of a user using the account in response to receiving the request;

compare the retrieved score with a threshold to determine whether or not the retrieved score is equal to or higher than the threshold; and

approve the request to update the authorization amount in the transaction request if it is determined that the retrieved score is equal to or higher than the threshold.

In a second aspect, there is a method for managing an authorization amount shown in a transaction request over a plurality of payments using an account, the authorization amount exceeding a limit determined for the account, the method comprising:

receiving a request to update the authorization amount with a transaction amount, the request indicating account details corresponding to the account, the transaction amount and the transaction amount to be paid in one of the plurality of payments;

retrieving, from a predetermined database, a score representing a credibility of a user using the user account in response to receiving the request;

comparing the retrieved score with a threshold to determine whether or not the retrieved score is equal to or higher than the threshold; and

approving the request to update the authorization amount in the transaction request if it is determined that the retrieved score is equal to or higher than the threshold.

### BRIEF DESCRIPTION OF THE DRAWINGS

Embodiments of the invention will be better understood and readily apparent to one of ordinary skill in the art from the following written description, which provides examples only, and in conjunction with the drawings in which:

FIG. 1 shows a block diagram illustrating a server for managing an authorization amount shown in a transaction request over a plurality of payments according to various embodiments;

FIG. 2 shows a flow diagram illustrating a method for managing an authorization amount shown in a transaction request over a plurality of payments according to various embodiments;

FIG. 3 shows a further detailed flow of the method as shown in FIG. 2;

FIG. 4 shows a server including modules for managing an authorization amount shown in a transaction request over a plurality of payments according to various embodiments;

FIG. 5 shows an exemplary server for managing a request to settle an authorization amount according to various embodiments.

### DETAILED DESCRIPTION

Overview

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, “receiving”, “retrieving”, “identifying”, “predicting” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

Various embodiments provide servers and methods for managing an authorization amount shown in a transaction request over a plurality of payments using an account.

The following disclosure provides a solution for addressing or mitigating at least one of the above discussed drawbacks. One solution is to manage an authorization amount shown in a transaction request over a plurality of payments using an account. Conventionally, a credit limit which is determined for the account is used to determine whether or not to approve a transaction. The credit limit is compared with an authorization amount and if the credit limit is equal to or higher than the amount of the transaction, the transaction is approved. However, relying only on the credit limit to determine whether or not to process the transaction lacks flexibility. For example, the transaction cannot proceed just because a credit limit is lower than the authorization amount regardless of any other factors. In the following disclosures, it is determined whether or not an owner (or user) corresponding to the account is reliable and credible and enhances flexibility to determine whether or not to approve the transaction in view of such parameters. In this context, the term ‘reliable’ means a risk for the user using the account to become a bad debtor is low. For example, the user using the account is likely to pay for an amount as scheduled. In other words, the user is credible or has a high credit score. A credit score represents a credibility of the user using the account and can be used to determine whether or not the user account is reliable. The credit score is an indicator that can be used to estimate a risk to provide a service such as a payment for an authorization amount over a plurality of payments. Each of the plurality of payments is a transaction.

In an example, the authorization amount, as shown in a transaction request, is to be paid over a plurality of payments and the amount to be paid in each of the plurality of payments (or a transaction amount in each of the plurality of payments) may be identified. A transaction request is one that is initiated by the user to purchase one or more products and indicates an authorization amount representing an amount of the one or more products. If it is determined that a user using the account is reliable based on his credit score, the amount (or a corresponding transaction amount in each of the plurality of payments) to be paid in each of the plurality of payments may be compared with credit limit of the account. Even if the credit limit of the account is lower than the authorization amount, the transaction may be approved if it is determined that the credit limit is equal to or higher than the amount to be paid in each of the plurality of payments. Determining whether or not to approve the transaction based on the reliability of the user using the account in addition to taking into account of the credit limit will advantageously provide an opportunity for purchasing a product based on an account whose credit limit is lower than the authorization amount. That is, the amount to be considered for the transaction request will be updated from an authorization amount.

Although only a credit score party (or a credit bureau) is discussed in relation to the reliability of the user using the account in the above, there are other criteria to represent the reliability of the user using the account. For example, a type of user account may be taken into account to determine whether or not to approve the transaction.

### Terms Description (in Addition to Plain and Dictionary Meaning of Terms)

Unless context dictates otherwise, the following terms will be given the meaning provided here:

The term “credit limit” refers to a limit or a maximum amount that may be spent, either in debit or credit, within a period (usually a month) for an account. The credit limit may be used to compare with an amount of one or more products to be purchased (or an authorization amount) to determine whether or not to approve the transaction. Although the term “credit limit” or “limit” is used in this disclosure, any other terminologies can be applicable in a similar manner.

The term “credit score” refers to a score representing the credibility of a user using an account. The score may be one that is determined based on historical transactions that have been conducted using the account. In other words, the score represents the past behavior of the user using the account. The score may be determined and/or saved by a credit bureau such as a consumer reporting agency, a credit reference agency, a credit reporting body, a credit information company or any other parties.

The term “account” refers to one that is suitable for a transaction for the purpose of purchasing a good and/or a service (or a product). The account may be a payment card or a digital wallet. A payment card is a card that can be used by an account holder for a transaction with a merchant. In the following description, the term “payment cards” refer to any suitable transaction cards, such as credit cards, debit cards, prepaid cards, charge cards, membership cards, promotional cards, frequent flyer cards, identification cards, gift cards, and/or any other device that may hold payment account information, such as mobile phones, Smartphones, personal digital assistants (PDAs), key fobs, and/or computers. Each type of payment card can be used as a method of payment for performing a transaction.

In the following description, a digital wallet is an account that can be used by a digital wallet user for a transaction with a merchant. The digital wallet is usually linked to a digital wallet user's bank account or a digital wallet user's payment card. Typically, the payments by digital wallets are facilitated by a different entity such as Google®, Apple® or PayPal®. Additionally or alternatively, the payments by digital wallets are facilitated by an entity who also manages the payment cards such as Mastercard®. Such transactions that are made using the digital wallets are also known as wallet-based transactions.

The term “installment” refers to one of a plurality of payments for a transaction that is made on a payment scheme (or installment plan).

The term “authorization amount” refers to an amount to be paid for one or more products indicated in a transaction request corresponding to a transaction. It may be indicated in a request for managing the transaction in a plurality of payments, each of the plurality of payments having a corresponding transaction amount. The transactions amounts corresponding to the plurality of payments for a single transaction may be different. For various embodiments, the authorization amount shown in the transaction request may be replaced if the credit score of a user is equal to or higher than the threshold.

The term “database” or “databases” refer to any databases located within a computing system or remote server such as a computer in a cloud server. The database or databases may each be a cloud database running on a cloud computing platform.

### Exemplary Embodiments

Embodiments of the present invention will be described, by way of example only, with reference to the drawings. Like reference numerals and characters in the drawings refer to like elements or equivalents.

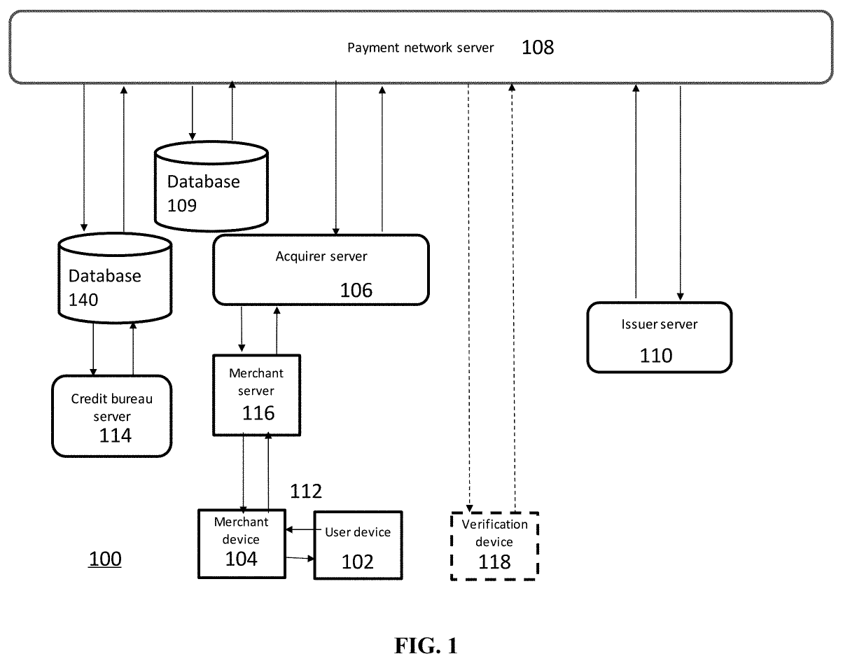

FIG. 1 shows a block diagram illustrating a server for managing an authorization amount according to various embodiments. In an example, the managing of the request to settle the authorization amount is performed by at least a user device 102, a merchant server 104, an acquirer server 106, a payment network server 108, a credit bureau server 114, an issuer server 110, a verification device 118 and a merchant device 104.

The system 100 comprises a user device 102 in communication with a merchant device 104. The user device 102 may also be in direct communication with a payment network server 108, without having to communicate with the merchant device 104.

The merchant device 104 is in communication with a merchant server 116 which is in turn in communication with an acquirer server 106. The acquirer server 106, in turn, is in communication with the payment network server 108. The payment network server 108, in turn, is in communication with an issuer server 110.

Use of the term ‘server’ herein can mean a single computing device or a plurality of interconnected computing devices which operate together to perform a particular function. That is, the server may be contained within a single hardware unit or be distributed among several or many different hardware units.

In an example, the user device 102 may be one which sends a request to settle a authorization amount over a plurality of payments using an account. The amount to be paid in each of the plurality of payments is a transaction amount. In an example, the user device 102 may be a fixed (wired) computing device or a wireless (portable) computing device. In specific implementations, the user device 102 may be a handheld or portable or mobile device carried or used by the customer, or may refer to other types of electronic devices such as a personal computer, a land-line telephone or an interactive voice response (IVR) system and the like. The mobile device may be a device, such as a mobile phone, a laptop computer, a personal digital computer (PDA), a mobile computer, a portable music player (such as an iPod™ and the like).

The merchant device 104 is typically associated with the merchant who is also a party to the transaction that occurs between the user device 102 and the merchant device 104 through the transaction. The merchant device 104 may be a point-of-sale (POS) terminal, an automatic teller machine (ATM), a personal computer, a computer server (hosting a website, for example), an IVR system, a land-line telephone, or any type of mobile device such as a mobile phone, a personal digital assistant (PDA), a laptop computer, a tablet computer and the like.

The merchant device 104 may receive, from the user device 102, a request to settle an authorization amount over a plurality of payments using an account and forward the request to the acquirer server 106, directly or indirectly via the merchant server 116.

The acquirer server 106 is generally associated with an acquirer who may be an entity (e.g. a company or organization) which issues (e.g. establishes, manages, administers) a transaction credential or an account (e.g. a financial bank account) of the merchant. Examples of the acquirer include a bank and/or other financial institution. As stated in the above, the acquirer server 106 may include one or more computing devices that are used to establish communication with another server by exchanging messages with and/or passing information to the other server.

The acquirer server 106 may be configured to communicate with the merchant device 104, the merchant server 116 and the payment network server 108. In an example, the acquirer server 106 may receive, from the merchant server 116, the request to approve a transaction for the user account and forward the request to the payment network server 108.

The payment network server 108 typically is associated with a payment facilitator. For example, the payment network server 108 may be the Banknet® network operated by MasterCard®. The payment facilitator (e.g. MasterCard®) may be an entity (e.g. a company or organization) who operates to process transactions, clear and settle funds for payments between two entities (e.g. two banks). The payment network server 108 may include one or more computing devices that are used for processing transactions.

In an example, the payment network server 108 may be a server managing a request to settle an authorization amount. The payment network server 108 may be configured to communicate with the acquirer server 106, the credit bureau server 114 and the issuer server 110. Optionally, the payment network server 108 may be configured to communicate with the verification device 118. In an example, the payment network server 108 may retrieve a credit score of an account from the credit bureau server 114 in response to the request to settle the transaction in a plurality of payments.

The issuer server 110 is generally associated with an issuer and may include one or more computing devices that are used to perform a payment transaction. The issuer may be an entity (e.g. a company or organization) which issues (e.g. establishes, manages, administers) a transaction credential or an account (e.g. a financial bank account). An account may be associated with a plurality of user devices 102.

The payment network server 108 may be configured to communicate with, or may include, a database (or a transaction database) 109. The transaction database 109 stores data corresponding to a transaction (or transaction data). Examples of the data include Transaction ID, Merchant ID, Merchant Name, Merchant Category Code/Industry Code, Industry Description, Merchant Country, Merchant Address, Merchant Postal Code, Aggregate Merchant ID. For example, data (“Merchant name” or “Merchant ID”) relating to the merchant, time and date for which the goods/services relating to the transaction will be delivered are included in the database 109. In specific implementations where the user has selected to settle a historical transaction in a plurality of payments (or an installment scheme), the transaction database 109 may include details relating to the historical transactions. For example, the transaction database 109 may include information on whether or not the user having an account has settled historical transactions, especially those on a plurality of payments, within a predetermined time period that is decided for each of the plurality of payments. This time period may be selectable by the user or determined by an entity facilitating the payment (e.g., an issuer, an acquirer or a payment facilitator).

The credit bureau server 114 is generally associated with a credit bureau or credit score entity and may include one or more computing devices that are used to manage a payment scheme involving a plurality of payments. The credit bureau may be an entity (e.g. a company or organization) which handles (e.g. establishes, manages, administers) a payment scheme involving paying a transaction over a plurality of payments. The credit bureau server 114 may be configured to communicate with a database (or credit bureau database 140) having information relating to a request to manage an authorization amount over a plurality of payments. That is, if there is a request to manage an authorization amount over a plurality of payments, the database 140 and/or the database 109 may be updated and the entity managing the data may proceed to monitor the payment scheme. In an embodiment, the transaction database 109 may be one that is accessible to the credit bureau server 114. In an embodiment, the database 109 is also the database 140. In another embodiment, the database 109 and the database 140 can be separate.

The verification device 118 may be a wired computing device or a wireless computing device. In an embodiment, the verification device 118 may be a handheld or portable or mobile device carried or used by the user, or may refer to other types of electronic devices such as a personal computer, a land-line telephone, an IVR system, and the like. In some embodiments, a mobile device may be a device, such as a mobile phone, a laptop computer, a personal digital computer (PDA), a mobile computer, a portable music player (such as an iPod™ and the like), that has a suitable application stored, loaded or otherwise installed in or on the mobile device such that the holder can be contacted at a verification address (e.g. a land-line telephone number, a mobile phone number or an electronic mail address). In an embodiment, the user device 102 is also the verification device 118. In another embodiment, the user device 102 and the verification device 118 can be separate devices.

The user device 102 is capable of wireless communication using a suitable protocol with the merchant device 104. For example, embodiments may be implemented using user devices 102 that are capable of communicating with WiFi/Bluetooth-enabled merchant devices 104. It will be appreciated by a person skilled in the art that depending on the wireless communication protocol used, appropriate handshaking procedures may need to be carried out to establish communication between the user device 102 and the merchant device 104. For example, in the case of Bluetooth communication, discovery and pairing of the user device 102 and the merchant device 104 may be carried out to establish communication.

In an example, during a transaction, a transaction request message (or a transaction request) 112 is generated at the user device 102 in response to the user (or customer) making a selection of a good and/or service to be purchased from the merchant. In other words, the transaction request message 112 relates to a transaction between the user and the merchant. The transaction may be performed via a website of the merchant. For example, the user device 102 may be used to surf a website, like Amazon®. In specific implementations, the user device 102 may be fitted with a wireless communications interface such as a Near Field Communication (NFC) interface to enable the user device 102 to electronically communicate with the merchant device 104 to perform the transaction. NFC is a set of standards to establish radio communication between devices by bringing them into close proximity such as only a few centimeters. NFC standards cover communication protocols and data exchange formats, and are based on radio-frequency identification (RFID) technology.

Each transaction data relates to a transaction and identifies the user and the merchant, generally by way of identifiers of each transaction associated with the user and merchant respectively. Further, the transaction data may also identify the good and/or service to be purchased and a type or nature of the transaction. The transaction data may further identify a value or price of the good and/or service (e.g., a transaction amount) and a location where the good and/or service will be delivered. The transaction data may also indicate a time and date at which the transaction was initiated by the user.

The following types of transaction data may be included in the transaction request message 112:
Transaction level information:—
   Transaction ID
   Account ID (anonymized)
   Merchant ID
   Transaction Amount
   Transaction Local Currency Amount
   Date of Transaction
   Time of Transaction
   Type of Transaction
   Date of Processing
   Cardholder Present Code
   Merchant Category Code (MCC)
   Details of Payment Scheme (No. of payments and period of payment scheme)
Account (or Profile) Information:—
   Account ID (anonymized)
   Card Group Code
   Card Product Code
   Card Product Description
   Card Issuer Country
   Card Issuer ID
   Card Issuer Name
   Aggregate Card Issuer ID
   Aggregate Card Issuer Name
Merchant Information:—
   Merchant ID
   Merchant Name
   MCC/Industry Code
   Industry Description
   Merchant Country
   Merchant Address
   Merchant Postal Code
   Aggregate Merchant ID
   Aggregate Merchant Name
   Merchant Acquirer Country
   Merchant Acquirer ID
Issuer Information:—
   Issuer ID
   Issuer Name
   Aggregate Issuer ID
   Issuer Country

The transaction request message 112 is sent from the user device 102 to the merchant device 104. In a disclosed embodiment, for example, where the transaction is being performed at the website of the merchant, the user device 102 and the merchant device 104 are in communication with a network, such as, the Internet (not shown for the sake of simplicity). In this example, the transaction request message 112 is sent from the user device 102 to the merchant device 104 via the network.

As mentioned above, the role of the payment network server 108 is to facilitate communication between the acquirer server 106 and the issuer server 110. Therefore, the payment network server 108 may serve as a means through which the acquirer server 106 may communicate with the issuer server 110 in a manner that payments and authentication may be performed. In specific implementations, the payment network server 108 may receive transaction data when settling a transaction for a user and subsequently store/update the transaction data in the database 109 or the database 140, respectively.

The credit bureau server 114 may be different and separate from the payment network server 108. Alternatively, the credit bureau server 114 may be part of the payment network server 108. In specific implementations, the payment network server 108 is further configured to perform additional operations. For example, the payment network server 108 may be configured to update the database 109 whenever a user initiates a request to settle a transaction in a plurality of payments. Additionally, the payment network server 108 may also be configured to determine a credibility score for the user associated with the account based on an analysis of the historical transaction data.

The transaction authorization process described above involves multiple parties (e.g., account holder, merchant, acquirer, issuer, credit bureau, payment facilitator). However, the transaction authorization process may be essentially viewed as a transaction between an account holder (or a user) and a merchant (with the other parties facilitating the transaction).

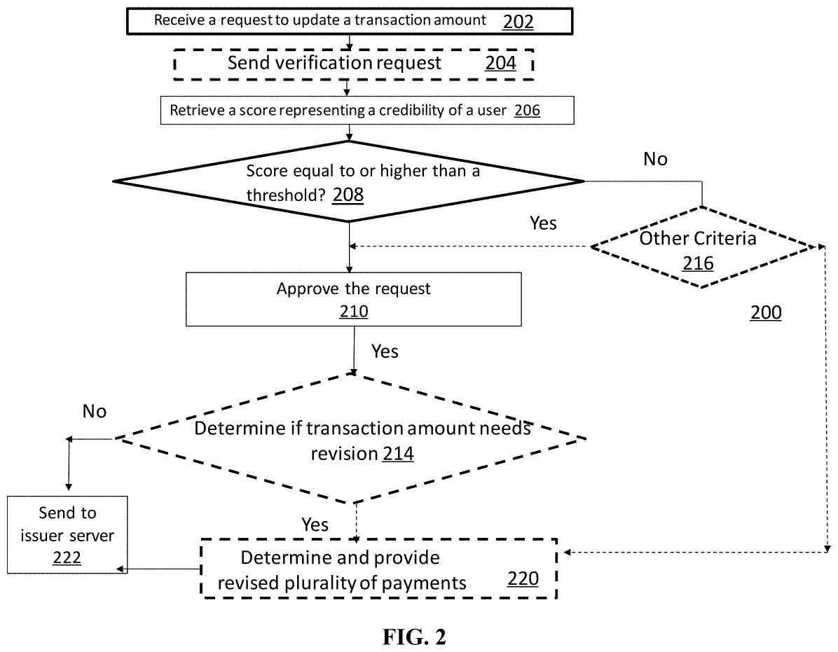

FIG. 2 shows a flow diagram illustrating a method for managing a request to settle an authorization amount according to various embodiments. The authorization amount (e.g., USD 15,000) indicated in a transaction request is one that exceeds a limit (e.g., USD 5,000) determined for an account. Using conventional techniques, such a transaction request would be declined.

Referring to FIG. 2, at step 202, a request is received to update the authorization amount as indicated in a transaction request with a transaction amount. In an implementation, the request indicates details corresponding to the account, the authorization amount, the number of the plurality of payments and an amount to be paid in each of the plurality of payments. The amount may be known as a transaction amount. The number of payments represents a frequency of payments. For example, the number of payments may be in terms in months or days. The payment for each of the number of payments (or a transaction amount) may be determined based on the number of payments and the authorization amount. By updating the authorization amount, it may mean replacing how the authorization amount is indicated in the transaction request.

At step 204, the method further comprises sending a verification request to the verification device 118. Alternatively, the verification request may be sent to the user device 102 which may be used to send the request at step 202. For example, the verification request may be sent via an SMS message to their pre-designated mobile phone number. In this case, the mobile phone may be the verification device and the SMS may be the out-of-band message. The verification device 118 receives an input from a user of the verification device 118. The verification device 118 may be configured to receive the input from a user of the verification in response to outputting the verification request. The input is sent to the payment network server 108 who will determine if the user who makes the request as set out at step 202 is the owner of the account.

At step 206, a score (or credit score) representing the credibility of a user using the account is retrieved from a predetermined database. This may be done by retrieving the score corresponding to an identifier indicated in the request. The identifier identifying the user or the account. In order to do so, this step comprises referring to one or more databases (e.g., databases 109, 140 that stores the profile of a user or details of the historical transactions associated with the account. At step 208, the retrieved score is compared with a threshold to determine whether or not the retrieved score is equal to or higher than the threshold. In an embodiment, the threshold may correspond to a type or an authorization amount of the request received at step 202. The threshold represents the minimum credibility that is acceptable for the transaction associated with the request received at step 202. At step 216, other steps may be carried out if the retrieved score is lower than the threshold.

At step 210, the request to update the authorization amount in the transaction request is approved if it is determined that the retrieved score is equal to or higher than the threshold at step 208. In other words, the transaction amount may be updated if the score retrieved is equal to or higher than the threshold, without further revisions.

At step 214, each transaction amount for each of the plurality of payments is identified from the request received at step 202. This step is performed in response to obtaining an approval of updating the authorization amount indicated in the transaction request. That is, each transaction amount is compared with the limit determined for the account to determine if the plurality of payments or the transaction amounts requires revision. A type of the payment scheme is identified based on the authorization amount and the number of payments or transaction amounts indicated in the request. For example, if the authorization amount is USD 15,000 and the number of payments is three times over a period of three months. In other words, it is one payment (or installment) per month. The transaction amount to be paid in each payment may be USD 5,000 if the user indicates so. In such an example, where the monthly installment is the same, the type of the payment scheme may also be referred to as an equated monthly installment (EMI). For EMI type of transaction, the transaction amount replacing the authorization amount in the transaction request by end of the time period for each of the plurality of the payments is the same.

Following the above example, the EMI of USD 5,000 will be compared with the limit of USD 5,000 set for the account. It does not require revision because the transaction amount is equal to the limit.

At step 222, if it is determined that the transaction amount does not require revision, the transaction amount will replace the authorization amount and the transaction request may be handled in a manner consistent with a multiple-party payment system and the funds with transferred corresponding to the identified amount within a time period of each of the plurality of payments. That is, a request to transfer the transaction amount will be sent to the issuer server 110.

Alternatively, the transaction amount indicated for each of the plurality of payments may be determined to be different too. For example, if the number of payments is three times over a period of three months for an authorization amount of USD 15,000, each transaction amount may be determined to be at USD 4,500, USD 4,500 and USD 6,000.

At step 220, revision of one or more transaction amounts or payment terms will be determined and provided to the user if the transaction amount is more than the limit. For example, the payment of USD 6,000, which is more than the limit, may be revised to two more payments at USD 3,000 (or revised transaction amounts) for each payment or USD 4,000 in one payment and USD 2,000 in another. In other words, the transaction amounts indicated in the requests are revised before replacing the transaction amount in the transaction request. In an embodiment, the revised one or more transaction amounts or payment terms may require approval from the user.

Once the authorization amount is updated with the revised transaction amount, the transaction request may be handled in a manner consistent with a multiple-party payment system and the funds with transferred corresponding to the identified amount within a time period of each of the plurality of payments. That is, the revision of request to transfer the transaction amount will be sent to the issuer server 110.

The method described above involves multiple steps from step 202 to step 220. However, the method may essentially be one having steps 202, 206, 208 and 210.

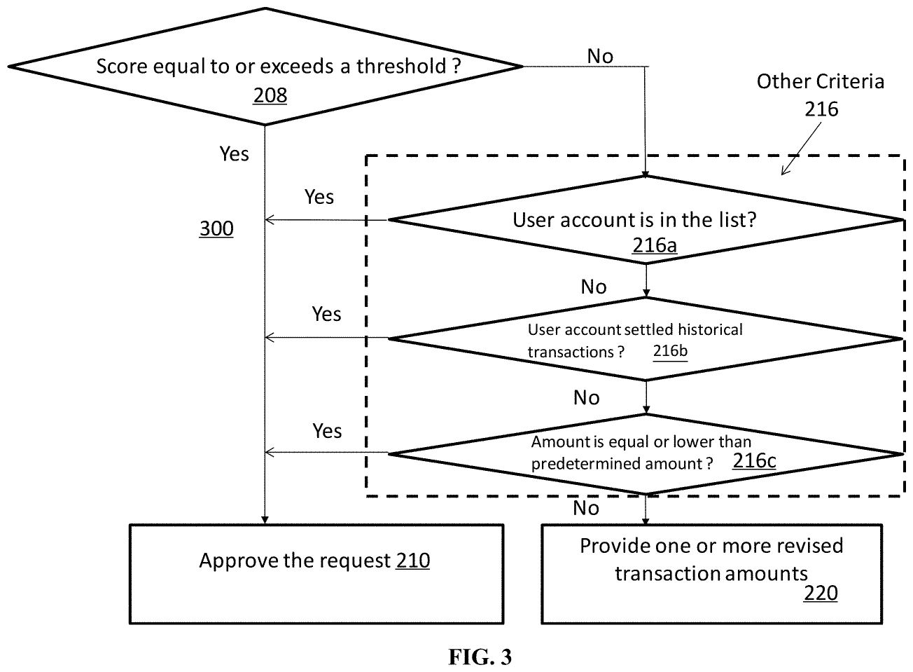

FIG. 3 shows a further detailed flow of step 216 as shown in FIG. 2. As mentioned in the above, if it is determined that the retrieved score is not higher than or equal to the threshold, other steps may be carried out.

In an embodiment, if the retrieved score is not higher than or equal to the threshold at step 208, the method may comprise determining whether or not the type of the account is included in a predetermined list listing the types of accounts authorized to settle the transaction amount over the plurality payments at step 216a. For example, for transactions where the authorization amount is smaller (e.g., $5500), it may be possible to authorize the request to update the authorization amount in the transaction request in response to step 216a if the type of the account is a credit card.

Additionally or alternatively to step 216a, at step 216b, the method may comprise determining if the account has been used to settle historical transactions within a predetermined time period. That is, in the event that the user associated with the account does not have a good credit score, the method may comprise looking into the recent payments used the account to determine if the user associated with the account is one who is likely to have a better credit score (or one who is financially credible). In doing so, this step considers if users, who do not have a good credit score overall, are likely to increase their credit score. The request to update the authorization amount in the transaction request will be approved in response to step 210 if it is determined that the user using the user account has settled recent historical transactions within a predetermined time period.

Additionally or alternatively to step 216a or 216b, the method may comprise determining if the account is one that is subscribed to a service for managing the request to settle the authorization amount over the plurality of payments at step 216c. For example, a user may choose to subscribe to a service that allows him to make a request to settle the transaction amount over a plurality of payments, even when his credit score may not be high. The service may be one that is provided by the payment network server. The request to update the transaction amount in the transaction request will be approved in response to step 216c if it is determined that the account is the one that is subscribed to the service. In doing so, this step allows users, who may be new account owners and hence do not have good credit scores, to initiate a request.

In the event that one or more of steps 216a to 216b is determined to be “No”, the request to update the authorization amount in the transaction request may not be approved, similar to step 220. That is, revised one or more transaction amounts or payment terms will be determined and provided to the user.

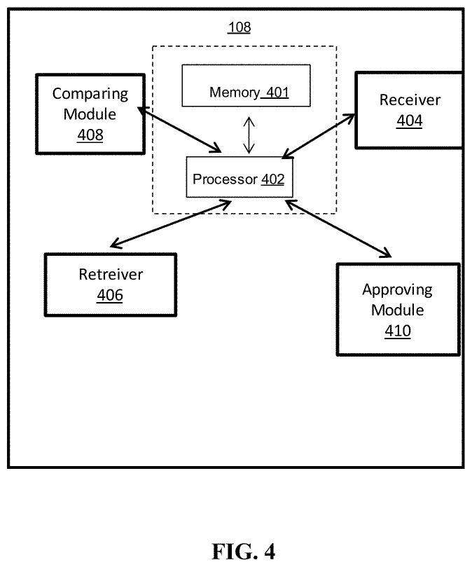

FIG. 4 shows a server including modules for managing a request to settle an authorization amount according to various embodiments. In an implementation, the payment network server 108 may be generally described as a physical device comprising at least one processor 402 and at least one memory 401 including computer program code. The at least one memory 401 and the computer program code are configured to, with the at least one processor 402, cause the physical device to perform the operations described in FIGS. 2 and 3. An example of payment network server 108 is shown in FIG. 4. The payment network server 108 shown in FIG. 4 may also include a receiver 404, a retriever 406, a comparing module 408 and an approving module 410. The memory 401 stores computer program code that the processor 402 compiles to have each of the receiver 404, the retriever 406, the comparing module 408 and the approving module 410 perform their respective functions. With reference to FIG. 1, the receiver 404 is configured to receive the request to settle the transaction amount in a plurality of payments. The retriever 406 is configured to retrieve, from a database 109, 140, a credibility score of an account indicated in the request. The comparing module 408 is configured to compare the retrieved score with a threshold. The approving module 410 is configured to approve the request if it is determined that the retrieved score is equal to or higher than the threshold.

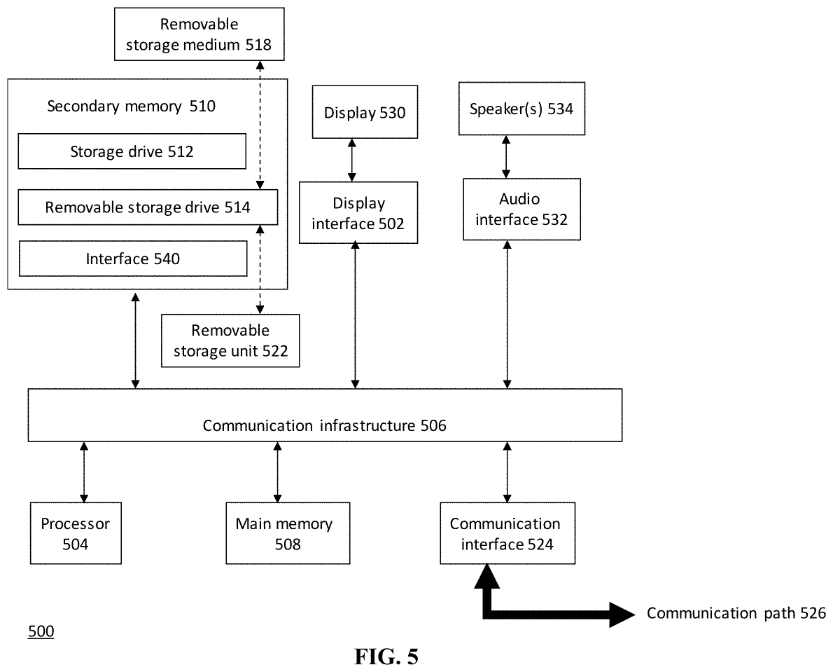

FIG. 5 depicts an exemplary computer/computing device 500, hereinafter interchangeably referred to as a computer system 500, where one or more such computing devices 500 may be used to facilitate execution of the above-described method. In addition, one or more components of the computer system 500 may be used to realize the payment network server 108. The following description of the computing system 500 is provided by way of example only and is not intended to be limiting.

As shown in FIG. 5, the example computing system 500 includes a processor 504 for executing software routines. Although a single processor is shown for the sake of clarity, the computing device 500 may also include a multi-processor system. The processor 504 is connected to a communication infrastructure 506 for communication with other components of the computing device 500. The communication infrastructure 506 may include, for example, a communications bus, cross-bar, or network.

The computing device 500 further includes a main memory 508, such as a random access memory (RAM), and a secondary memory 510. The secondary memory 510 may include, for example, a storage drive 512, which may be a hard disk drive, a solid state drive or a hybrid drive and/or a removable storage drive 514, which may include a magnetic tape drive, an optical disk drive, a solid state storage drive (such as a USB flash drive, a flash memory device, a solid state drive or a memory card), or the like. The removable storage drive 514 reads from and/or writes to a removable storage medium 518 in a well-known manner. The removable storage medium 518 may include magnetic tape, optical disk, non-volatile memory storage medium, or the like, which is read by and written to by removable storage drive 514. As will be appreciated by persons skilled in the relevant art(s), the removable storage medium 518 includes a computer readable storage medium having stored therein computer executable program code instructions and/or data.

In an alternative implementation, the secondary memory 510 may additionally or alternatively include other similar means for allowing computer programs or other instructions to be loaded into the computing device 500. Such means can include, for example, a removable storage unit 522 and an interface 540. Examples of a removable storage unit 522 and interface 540 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 522 and interfaces 540 which allow software and data to be transferred from the removable storage unit 522 to the computer system 500.

The computing device 500 also includes at least one communication interface 524. The communication interface 524 allows software and data to be transferred between computing device 500 and external devices via a communication path 526. In various embodiments of the inventions, the communication interface 524 permits data to be transferred between the computing device 500 and a data communication network, such as a public data or private data communication network. The communication interface 524 may be used to exchange data between different computing devices 500 which such computing devices 500 form part an interconnected computer network. Examples of a communication interface 524 can include a modem, a network interface (such as an Ethernet card), a communication port (such as a serial, parallel, printer, GPIB, IEEE 1394, RJ25, USB), an antenna with associated circuitry and the like. The communication interface 524 may be wired or wireless. Software and data transferred via the communication interface 524 are in the form of signals which can be electronic, electromagnetic, optical or other signals capable of being received by communication interface 524. These signals are provided to the communication interface via the communication path 526.

As shown in FIG. 5, the computing device 500 further includes a display interface 502 which performs operations for rendering images to an associated display 530 and an audio interface 532 for performing operations for playing audio content via associated speaker(s) 534.

As used herein, the term “computer program product” may refer, in part, to removable storage medium 518, removable storage unit 522, a hard disk installed in storage drive 512, or a carrier wave carrying software over communication path 526 (wireless link or cable) to communication interface 524. Computer readable storage media refers to any non-transitory, non-volatile tangible storage medium that provides recorded instructions and/or data to the computing device 500 for execution and/or processing. Examples of such storage media include magnetic tape, CD-ROM, DVD, Blu-Ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a SD card and the like, whether or not such devices are internal or external of the computing device 500. Examples of transitory or non-tangible computer readable transmission media that may also participate in the provision of software, application programs, instructions and/or data to the computing device 500 include radio or infra-red transmission channels as well as a network connection to another computer or networked device, and the Internet or Intranets including e-mail transmissions and information recorded on Websites and the like.

The computer programs (also called computer program code) are stored in main memory 508 and/or secondary memory 510. Computer programs can also be received via the communication interface 524. Such computer programs, when executed, enable the computing device 500 to perform one or more features of embodiments discussed herein. In various embodiments, the computer programs, when executed, enable the processor 504 to perform features of the above-described embodiments. Accordingly, such computer programs represent controllers of the computer system 500.

Software may be stored in a computer program product and loaded into the computing device 500 using the removable storage drive 514, the storage drive 512, or the interface 540. Alternatively, the computer program product may be downloaded to the computer system 500 over the communications path 526. The software, when executed by the processor 504, causes the computing device 500 to perform functions of embodiments described herein.

It is to be understood that the embodiment of FIG. 5 is presented merely by way of example. Therefore, in some embodiments one or more features of the computing device 500 may be omitted. Also, in some embodiments, one or more features of the computing device 500 may be combined together. Additionally, in some embodiments, one or more features of the computing device 500 may be split into one or more component parts.

For example, the method of FIGS. 2 and 3 may be implemented as software and stored in a non-transitory fashion in the secondary memory 510 or the removable storage units 518, 522 of the computer device 500.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “analyzing”, “determining”, “replacing”, “generating”, “initializing”, “outputting”, “receiving”, “retrieving”, “identifying”, “predicting” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses server for performing the operations of the methods. Such server may be specially constructed for the required purposes, or may comprise a computer or other device selectively activated or reconfigured by a computer program stored in the computer. The algorithms and displays presented herein are not inherently related to any particular computer or other server. Various machines may be used with programs in accordance with the teachings herein. Alternatively, the construction of more specialized server to perform the required method steps may be appropriate. The structure of a computer will appear from the description below.

It will be appreciated by a person skilled in the art that numerous variations and/or modifications may be made to the present invention as shown in the specific embodiments without departing from the spirit or scope of the invention as broadly described. For example, the above description mainly discusses the use of a Bluetooth connection, but it will be appreciated that another type of secure wireless connection, such as Wi-Fi, can be used in alternate embodiments to implement the method. Some modifications, e.g. adding an access point, changing the log-in routine, etc. may be considered and incorporated. The present embodiments are, therefore, to be considered in all respects to be illustrative and not restrictive.

What is claimed is:

1. A server for managing an authorization amount shown in a transaction request over a plurality of payments using an account, the authorization amount exceeding a limit determined for the account, the server comprising:
at least one processor; and
at least one memory including computer program code, the at least one memory and the computer program code configured to, with the at least one processor, cause the server at least to:
receive a request to update the authorization amount with a transaction amount, the request indicating account details corresponding to the account, the authorization amount and the transaction amount to be paid in one of the plurality of payments;
retrieve, from a predetermined database, a score representing a credibility of a user using the account in response to receiving the request;
compare the retrieved score with a threshold to determine whether or not the retrieved score is equal to or higher than the threshold; and
approve the request to update the authorization amount in the transaction request if it is determined that the retrieved score is equal to or higher than the threshold.

2. The server in accordance with claim 1, wherein the at least one memory and the computer program code configured to, with the at least one processor, cause the server further to:
identify a transaction amount to be paid in each of the plurality of payments in response to approving the request; and
compare the transaction amount to be paid in each of the plurality of the payments with the limit determined for the account to determine if the transaction amounts require revision.

3. The server in accordance with claim 2, wherein the at least one memory and the computer program code configured to, with the at least one processor, cause the server further to:
determine whether or not the transaction amount to be paid in each of the plurality of payments is equal to or lower than a predetermined amount; and
approve the request if it is determined that the transaction amount to be paid in each of the plurality of payments is equal to or lower than the predetermined amount.

4. The server in accordance with claim 1, wherein the at least one memory and the computer program code configured to, with the at least one processor, cause the server further to:
update the score relating to the user when managing a request to settle the authorization amount over a plurality of payments.

5. The server in accordance with claim 4, wherein the at least one memory and the computer program code configured to, with the at least one processor, cause the server further to:
determine whether or not the user using the account has settled historical transactions within a predetermined time period; and
approve the request if it is determined that the user using the account has settled historical transactions within a predetermined time period.

6. The server in accordance with claim 4, wherein the at least one memory and the computer program code configured to, with the at least one processor, cause the server further to:
determine whether or not the account is one that is subscribed to a service for managing the request to settle the authorization amount over the plurality of payments; and
approve the request if it is determined that the account is the one that is subscribed to the service.

7. The server in accordance with claim 1, wherein the request further indicates a type of the account, wherein the at least one memory and the computer program code configured to, with the at least one processor, cause the server further to:
determine whether or not the type of account is included in a predetermined list listing the types of accounts authorized to settle the authorization amount over the plurality of payments; and
approve the request if it is determined that the type of account is included in the predetermined list.

8. The server in accordance with claim 1, wherein the at least one memory and the computer program code configured to, with the at least one processor, cause the server further to:
send, to a verification device, a request for verifying the user using the account.

9. The server in accordance with claim 1, wherein the at least one memory and the computer program code configured to, with the at least one processor, cause the server further to:
determine a revised plurality of payment in response to the retrieved score; and
provide the revised plurality of payments.

10. A method for managing an authorization amount shown in a transaction request over a plurality of payments using an account, the authorization amount exceeding a limit determined for the account, the method comprising:
receiving a request to update the authorization amount with a transaction amount, the request indicating account details corresponding to the account, the transaction amount and the transaction amount to be paid in one of the plurality of payments;
retrieving, from a predetermined database, a score representing a credibility of a user using the user account in response to receiving the request;
comparing the retrieved score with a threshold to determine whether or not the retrieved score is equal to or higher than the threshold; and
approving the request to update the authorization amount in the transaction request if it is determined that the retrieved score is equal to or higher than the threshold.

11. The method in accordance with claim 10, further comprising:
identifying a transaction amount to be paid in each of the plurality of payments in response to receiving the request; and
comparing the transaction amount to be paid in each of the plurality of the payments with the limit determined for the account to determine if the transaction amounts require revision.

12. The method in accordance with claim 11, further comprising:
determining whether or not the transaction amount to be paid in each of the plurality of payments is equal to or lower than a predetermined amount; and
approving the request if it is determined that the transaction amount to be paid in each of the plurality of payments is equal to or lower than the predetermined amount.

13. The method in accordance with claim 10, further comprising:
updating the score relating to the user when managing a request to settle the authorization amount over a plurality of payments.

14. The method in accordance with claim 13, further comprising:
determining whether or not the account is one that is subscribed to a service for managing the request to settle the transaction amount over the plurality of payments; and
approving the request if it is determined that the account is the one that is subscribed to the service.

15. The method in accordance with claim 10, further comprising:
determining whether or not the type of account is included in a predetermined list listing the types of accounts authorized to settle the authorization amount over the plurality of payments; and
approving the request if it is determined that the type of account is included in the predetermined list.

16. The method in accordance with claim 10, further comprising:
determining whether or not the user using the account has settled historical transactions within a predetermined time period; and
approving the request if it is determined that the user using the account has settled historical transactions within a predetermined time period.

17. The method in accordance with claim 10, further comprising:
sending, to a verification device, a request for verifying the user using the account.

18. The method in accordance with claim 10, further comprising:
determining a revised plurality of payment in response to the retrieved score; and
providing the revised plurality of payments.

19. The method in accordance with claim 10, wherein each of the plurality of payments is an installment.
